(19) United States
(12) Patent Application Publication
(10) Pub. No.: US 2021/0084922 A1
(43) Pub. Date: Mar. 25, 2021

(54) CREAMER

(71) Applicant: SOCIETE DES PRODUITS NESTLE S.A., Vevey (CH)

(72) Inventors: Timothy James Wooster, Epalinges (CH); Axel Syrbe, Clarens (CH); Elyes Ben Sassi, Lausanne (CH); Ludovic Penseyres, Corseaux (CH); Olivier Schafer, Epalinges (CH)

(21) Appl. No.: 17/044,078

(22) PCT Filed: May 21, 2019
(86) PCT No.: PCT/EP2019/063034

§ 371 Date: Sep. 30, 2020

(30) Foreign Application Priority Data
May 22, 2018 (EP) 18173565.5

(51) Int. Cl. A23C 11/10; A23L 9/20; A23D 7/01

(52) U.S. Cl. CPC A23C 11/103; A23D 7/011; A23L 9/24

(57) ABSTRACT

A creamer composition wherein 0.1 to 15 wt % of the lipids in said composition are polar lipids, wherein the polar lipids comprise a glycolipid.

### FIELD OF THE INVENTION

The present invention relates to creamers comprising polar lipid emulsifiers. The present invention also relates to the use of polar lipid emulsifiers for enhancing the acid and/or mineral (calcium) stability of a creamer.

### BACKGROUND TO THE INVENTION

Creamers are widely used as whitening agents and texture/mouthfeel modifiers for hot and cold beverages, e.g., coffee, cocoa, tea, etc. They are commonly used as an alternative to milk or dairy cream. Creamers may come in a variety of different flavours and provide a whitening effect, mouthfeel, body, and a smoother texture, and may be in powdered or liquid form.

The creamer needs to be physically stable when added to foods and drinks made with water. Most dairy, non-dairy and plant based creamers experience physical separation in low pH and high mineral content beverages without the presence of buffers such as phosphates and emulsifiers. The physical separation is often referred to as flocculation, curdling, clumping, aggregation or sedimentation. For a creamer to perform well in a beverage, the creamer should be stable and free of aggregates or clumps when added to the beverage and until the beverage is completely consumed.

An existing solution to aggregation of coffee creamers when added to coffee is to use low molecular weight emulsifiers (e.g., mono and diglycerides and their esters) in combination with synthetic buffer agents (e.g., NaPhosphate and tripolyphosphate). This solution results in good technical performance, but uses synthetic agents which have negative consumer perception. More and more consumers are concerned by additives that may be perceived as synthetic or artificial in food products.

Lecithins rich in phospholipids may replace synthetic emulsifiers. However, whilst such lecithins are natural, they have modest technical performance in coffee creamers.

Accordingly, there is a demand for commercially available creamers without synthetic additives.

### SUMMARY OF THE INVENTION

The inventors have surprisingly found that polar oils, such as oat oil, can be used to create a creamer that is surprisingly stable when added to water based drinks such as coffee and tea.

The polar lipids present in the oil create a highly stable emulsion that does not need synthetic emulsifiers, nor synthetic buffering agents.

The inventors have also discovered that processing oat oil using low temperature high vacuum distillation leads to an oat based oil blend that has substantially no odour or dark colour and is surprisingly able to stabilise creamer emulsions without the addition of buffering agents, protein emulsifiers or synthetic emulsifiers. This has significant benefits over existing methods of bleaching and deodorising of the oil at elevated temperatures which creates a black pigment/gum leading to spoilage of the oil blend and the creation of an unappealing burnt/caramel aroma and taste.

The inventors have also surprisingly found that emulsions made using a combination of glycolipids and phospholipids did not inhibit or slow fat digestion thereby allowing the creation of natural emulsion based creamers that do not have negative nutritional consequences.

According to a first aspect of the present invention there is provided a creamer composition wherein 0.1 to 15 wt % of the lipids in said composition are polar lipids, wherein the polar lipids comprise a glycolipid.

In an embodiment, the total lipid content of the creamer composition is in the range 1% to 60% (weight/weight), for example in the range 5-55%, 10-50%, 20-30%. The lipids according to the invention may be oil.

In one embodiment, 0.4 to 14 wt %, 0.5 to 13 wt %, 0.6 to 12 wt %, 0.7 to 11 wt % or 0.7 to 10 wt % of the lipids in said composition may be polar lipids.

Preferably, at least 5, 10, 15, 20, 30 or 40 wt % of the polar lipids are glycolipids. Preferably, at least 5, 10, 15, 20, 30 or 40 wt % of the polar lipids are galactolipids. Preferably, at least 5, 10, 15, 20, 30 or 40 wt % of the polar lipids are digalactosyldiacylglycerides.

In an embodiment, the creamer composition comprises 0.05 to 2% (weight/weight) glycolipids, for example 0.05 to 2% (weight/weight) glycolipids derived from oat. For example the creamer composition may comprise 0.1 to 1% (weight/weight) glycolipids, for example 0.1 to 1% (weight/weight) glycolipids derived from oat.

In an embodiment, the creamer composition comprises 0.05 to 1% (weight/weight) digalactosyldiacylglycerides, for example comprises 0.05 to 1% (weight/weight) digalactosyldiacylglycerides derived from oat. For example the creamer composition may comprise 0.09 to 0.9% (weight/weight) digalactosyldiacylglycerides, for example 0.09 to 0.9% (weight/weight) digalactosyldiacylglycerides derived from oat.

The polar lipids may also comprise phospholipids.

In one embodiment, less than 85, 80, 60, 40, 20, 15, 10, 8, 6, 4 or 2 wt % of the polar lipids may be phospholipids.

Preferably the polar lipids comprise at least 15 wt % phospholipids. In one embodiment, the polar lipids comprise at least 16, 17, 18, 19 or 20 wt % phospholipids.

For example, the polar lipids may comprise 15 to 85 wt % phospholipids or 20 to 80 wt % phospholipids.

In one embodiment the lipids may comprise glycolipids and phospholipids at a weight ratio of at least 1:5 glycolipids to phospholipids, for example at least 1:4, at least 1:3, at least 1:2 or at least 1:1.5. The lipids may comprise glycolipids and phospholipids at a weight ratio of 1:5 to 3:1, for example about 1:4 to 2:1 or 1:3 to 1:1.

The quantity of glycolipids and phospholipids may be determined by, for example, quantitative 31P-NMR (phospholipids) and quantitative 1H-NMR (glycolipids) with internal standards.

The polar lipids may be from edible plants. The polar lipids may be obtained from plants selected from the group consisting of oats; legumes (e.g., common bean, pea); leaf vegetables (e.g., kale, leek, parsley, perilla and spinach); stem vegetables (e.g., asparagus, broccoli, Brussels sprouts); and fruit vegetables (e.g., chili, bell pepper, pumpkin). The polar lipids may be example fractionated oils e.g., fractionated oat, legume; leaf vegetable, stem vegetable or fruit vegetable oil.

The polar lipids may be derived from, for example, oat, spinach (e.g. spinach leaf) or sweet potatoes (e.g. sweet potato leaf). Preferably the polar lipids are derived from oat. The polar lipids may be from oat oil, for example fractionated oat oil.

In one embodiment, 1 to 35 wt % of the lipids in the creamer composition are derived from oat, and at least 4%, at least 15%, at least 35% or at least 40% by weight of the lipid derived from oat are polar lipids.

In one embodiment, 1 to 35 wt % of the lipids in the creamer composition are derived from oat and 65 to 99 wt % of the lipids in the composition are palm oil, palm kernel oil, hydrogenated palm kernel oil, coconut oil, algal oil, canola oil, soy bean oil (for example high oleic soy bean oil), sunflower oil (for example high oleic sunflower oil), safflower oil, cotton seed oil, milk fat, or corn oil.

In one embodiment, 5 to 25 wt % of the lipids in the creamer composition are derived from oat and 75 to 95 wt % of the lipids in the composition are palm oil, palm kernel oil, hydrogenated palm kernel oil, coconut oil, algal oil, canola oil, soy bean oil (for example high oleic soy bean oil), sunflower oil (for example high oleic sunflower oil), safflower oil, cotton seed oil, milk fat, or corn oil.

In a preferred embodiment, the oils derived from oat, spinach or sweet potato are prepared by low temperature high vacuum distillation.

The creamer composition may comprise a protein emulsifier, such as sodium caseinate, calcium caseinate, micellar casein, skim milk powder, whole milk powder, pea protein isolate, soy protein isolate or potato protein isolate

The creamer composition may comprise caseinate, such as sodium caseinate. In one embodiment, the creamer does not comprise caseinate, such as sodium caseinate.

In one embodiment, the creamer composition comprises no additional emulsifiers, that is no emulsifiers other than the polar lipids described herein.

In one embodiment, the creamer composition is substantially devoid of milk protein.

In one embodiment, the creamer composition is substantially devoid of added phosphates.

In one embodiment, the composition is a beverage creamer, such as a coffee creamer or a tea creamer.

The creamer may comprise, for example, 5-60 wt % oil and 5-95 wt % carbohydrate on a dry weight basis, for further example, 5-50 wt % oil and 5-95 wt % carbohydrate on a dry weight basis.

The creamer may be in the form of a powdered creamer.

The creamer may be in the form of a liquid creamer.

According to another aspect of the present invention there is provided a coffee beverage composition comprising the creamer composition of the present invention and a coffee component, preferably a dried coffee component.

According to another aspect of the present invention there is provided a ready-to-drink or ready to use beverage comprising a creamer of the present invention.

According to another aspect of the present invention there is provided use of a polar lipid as defined herein as an emulsifier in a creamer composition.

According to the use of the present invention the polar lipid is preferably oat oil, spinach oil or sweet potato oil or as defined herein.

Thus, there is provided use of oat oil, spinach oil or sweet potato oil as defined herein as an emulsifier in a creamer composition.

Preferably, the oat oil, spinach oil or sweet potato oil is prepared using low temperature high vacuum distillation.

According to the use of the present invention the polar lipid is preferably used to reduce acid and/or mineral (calcium) instability of a creamer composition.

Thus, there is provided use of polar lipids as defined herein to reduce acid and/or mineral (calcium) instability of a creamer composition.

In one embodiment, there is also provided use of oat oil, spinach oil or sweet potato oil to reduce acid and/or mineral (calcium) instability of a creamer composition.

According to another aspect of the present invention there is provided use of a creamer as defined herein for the preparation of capsules to be used in a beverage dispenser.

According to another aspect of the present invention there is provided a process for producing a creamer composition of the present invention comprising the steps of:

(i) providing an aqueous phase;

(ii) providing an oil phase by mixing a source of polar lipids as defined herein with an oil, such as an oil selected from the group consisting of palm oil, palm kernel oil or olein, hydrogenated palm kernel oil or olein, coconut oil, algal oil, canola oil, soy bean oil, sunflower oil, safflower oil, cotton seed oil, milk fat and corn oil;

(iii) combining the aqueous phase and the oil phase to form a pre-emulsion;

(iv) homogenising the pre-emulsion to form an emulsion concentrate;

(v) optionally drying the emulsion concentrate to form a dried creamer composition.

### DESCRIPTION OF FIGURES

FIG. 1—Particle size distribution of rehydrated powdered creamers from examples 1 and 2.

FIG. 2—Particle size distribution of liquid creamers from examples 3 and 4.

FIG. 3—Emulsion stability of creamer added directly to coffee made with Vittel water (natural bicarbonate buffer+310 ppm calcium). Optical pictures and optical micrographs of coffee creamer example emulsions made with i) reference creamer, ii) 0.9 wt % Na-Caseinate, iii) 0.5 wt % Oat Oil (PL40), or iv) 0.45 wt % Na-Caseinate and 0.2 wt % Oat Oil (PL40).

FIG. 4—Emulsion stability of creamer added directly to coffee made with reverse osmosis water+350 ppm calcium. Optical pictures and optical micrographs of coffee creamer example emulsions made with i) reference creamer, ii) 0.9 wt % Na-Caseinate, iii) 0.5 wt % Oat Oil (PL40), or iv) 0.45 wt % Na-Caseinate and 0.2 wt % Oat Oil (PL40).

FIG. 5—Emulsion stability of creamer added directly to coffee made with RO water+650 ppm calcium. Optical pictures and optical micrographs of coffee creamer example emulsions made with i) reference creamer, ii) 0.9 wt % Na-Caseinate, iii) 0.5 wt % Oat Oil (PL40), or iv) 0.45 wt % Na-Caseinate and 0.2 wt % Oat Oil (PL40).

### DETAILED DESCRIPTION

By a creamer composition is meant a composition that is intended to be added to a food composition, such as e.g. coffee, tea or soup, to impart specific characteristics such as colour (e.g. whitening effect), thickening, flavour, texture, and/or other desired characteristics. A creamer composition of the invention may be in powdered or liquid form.

Polar Lipid Emulsifier

By an emulsifier is meant a compound that stabilises the interface between the two phases of the oil-in-water emulsion and reduces the rate of phase separation.

The polar lipids used in the present invention act as emulsifiers.

Preferably between 0.1 to 15 wt % of the lipids in the creamer composition of the present invention are polar lipids.

For example, 0.4 to 14 wt %, 0.5 to 13 wt %, 0.6 to 12 wt %, 0.7 to 11 wt % or 0.7 to 10 wt % of the lipids in said composition may be polar lipids.

Preferably at least 15, 20, 25, 30, 35, 40, 45 or 50 wt % of the polar lipids are glycolipids.

Preferably at least 5, 10, 15, 20 or 25 wt % of the polar lipids are galactolipids.

Preferably at least 5, 10, 15, 20 or 25 wt % of the polar lipids are digalactosyldiacylglycerides.

The polar lipids may also comprise phospholipids.

In one embodiment, less than 85, 80, 60, 40, 20, 15, 10, 8, 6, 4 or 2 wt % of the polar lipids may be phospholipids.

Preferably the polar lipids comprise at least 15 wt % phospholipids. In one embodiment, the polar lipids comprise at least 15, 16, 17, 18, 19 or 20 wt % phospholipids.

For example, the polar lipids may comprise 15 to 85 wt % phospholipids or 20 to 80 wt % phospholipids.

In one embodiment the lipids may comprise glycolipids and phospholipids at a weight ratio of at least 1:5 glycolipids to phospholipids, for example at least 1:4, at least 1:3, at least 1:2 or at least 1:1.5. The lipids may comprise glycolipids and phospholipids at a weight ratio of 1:5 to 3:1, for example about 1:4 to 2:1 or 1:3 to 1:1.

The polar lipids may also comprise one or more of monogalactosylmonoglyceride, monogatactosyldiglyceride, digalactosylmonoglycerides or sterylglucoside.

The polar lipids may be derived from oat, spinach or sweet potatoes. Preferably the polar lipids are derived from oat. Examples of polar lipids that can be used in the invention are the following oat oils: SWEOAT Oil PL4, SWEOAT Oil PL15 or SWEOAT Oil PL40.

SWEOAT Oil PL4 comprises the following per 100 grams: Fat 99 g, comprising 4 g of polar lipids and 95 g of neutral lipids; saturated fatty acids 17 g; monounsaturated fatty acids 37 g, polyunsaturated fatty acids 45 g.

SWEOAT Oil PL15 comprises the following per 100 grams: Fat 97 g, comprising 15 g of polar lipids and 82 g of neutral lipids; saturated fatty acids 17 g; monounsaturated fatty acids 37 g; polyunsaturated fatty acids 45 g.

SWEOAT Oil PL40 comprises the following per 100 grams: Fat 98 g, comprising 40 g of polar lipids and 58 g of neutral lipids.

In one embodiment, oat oil may comprise the following per 100 grams: Fat 97 to 99 g, comprising 4 to 40 g of polar lipids (for example 2 to 20 g of glycolipids) and 58 to 95 g of neutral lipids.

Fats are lipids. In the context of the present invention oils are lipids. In the context of the present invention the terms fat and oil are used interchangeably.

Low Temperature High Vacuum Distillation

In one embodiment, the polar lipid is oat oil, spinach oil or sweet potato oil which has been processed using low temperature high vacuum distillation. In one embodiment, the polar lipid is oat oil which has been processed using low temperature high vacuum distillation. For example the polar lipid according to the invention may be prepared using low temperature high vacuum distillation at a pressure of between 0.001 to 0.03 mbar and a temperature between 30° and 75° C., for example 60° to 70° C.

In one embodiment, 0.5 to 30 wt %, 1 to 20 wt % or 2 to 15 wt % of the lipids in said composition are from oat oil, and at least 4%, at least 15%, at least 35% or at least 40 wt % of the oat oil lipids are polar lipids, wherein the polar lipids comprise one or more glycolipids.

It is known that oil blends created with oat oil extract have: i) a strong negative odour, ii) a strong dark colour and iii) an off-taste. These are undesirable properties that make products prepared using an oat based oil blend un-appealing to consumers. Therefore it is preferable that oat oil is refined prior to use to remove contaminants that adversely impact the appearance and performance.

The bleaching of edible oils and fats is a part of the refining process of crude oils and fats and is generally preceded by degumming and neutralization processes. Bleaching is required to remove specific detrimental contaminants that are not effectively removed by these processes before the oil progresses through deodorisation.

Processes for carrying out degumming, bleaching, deodorisation and fractionation are well known in the art.

Deodorisation is a stripping process in which a given amount of a stripping agent (usually steam) is passed for a given period of time through hot oil at a low pressure. Hence, it is mainly a physical process in which various volatile components are removed.

Existing solutions to deodorising/decolouring of oils consist of standard bleaching and deodorising at elevated temperatures (e.g., 230-260° C.). However, the present inventors have found that these temperature lead to the creation of a black pigment/gum which leads to spoilage of the oil blend. This pigment also leads to the creation of a burn/caramel aroma/taste which is un-appealing.

The inventors have surprisingly found that using low temperature high vacuum distillation for deodorising/decolouring leads to an oat based oil blend that has no odour, dark colour or off-taste.

Low temperature high vacuum distillation is a method of distillation performed under reduced pressure. A reduced pressure decreases the boiling point of compounds, allowing for a reduced temperature to be used. This is advantageous if the desired compounds are thermally unstable and decompose at elevated temperatures. The present inventors have surprisingly shown that the oat oil blend contains compounds which are thermally unstable and formed black pigment/gum when standard bleaching and deodorising was carried out at elevated temperatures. However, the inventors have shown that this can be avoided by using low temperature high vacuum distillation.

Accordingly, low temperature high vacuum distillation may be used to efficiently produce an oil blend that has no odour, dark colour or off-taste.

In one embodiment, the polar lipid is oat oil, spinach oil or sweet potato oil which has been processed using low temperature high vacuum distillation. In one embodiment, the polar lipid is oat oil which has been processed using low temperature high vacuum distillation.

Preferably the low temperature high vacuum distillation is low temperature high vacuum thin film distillation.

In one embodiment the pressure is 0.001 to 0.03 mbar and temperature is 30° to 75° C., for example 60° to 70° C.

Oil Component

The oil component of the creamer may be selected from different sources. In one embodiment, the oil component is selected from: palm oil, palm kernel oil or olein, hydrogenated palm kernel oil or olein, coconut oil, algal oil, canola oil, soy bean oil, sunflower oil, safflower oil, cotton seed oil, milk fat, or corn oil.

In one embodiment, the oil is present in the final creamer composition in an amount of at most about 60% (weight/weight) for example at most 50% (weight/weight). The amount of oil in the creamer composition may, for example, be about 1% to 60% (weight/weight), such as in the range 1-50%, 5-45%, 10-40%, 14-35%.

In the present context, unless otherwise specified, weight/weight percentages referred to herein are based on dry solids. When oil is included in the weight/weight percentages the % relates to the non-water part but including oil (solid content+oils).

Additional Agents

The creamer may comprise a buffering agent. The buffering agent can prevent undesired creaming or precipitation of the creamer upon addition into a hot, acidic and/or high mineral environment such as coffee. The buffering agent can be, for example, monophosphates, diphosphates, sodium mono- and bicarbonates, potassium mono- and bicarbonates, or a combination thereof. Preferred buffers are salts such as potassium phosphate, dipotassium. The buffer may e.g. be present in an amount of about 0.1 to about 3% by weight of the creamer.

In one embodiment, the creamer is devoid of added buffering agent. In one embodiment, the creamer is devoid of added phosphates. By added phosphates are meant phosphates which are added as substantially pure compounds, e.g. to obtain a buffering effect and/or for the purpose of stabilising the creamer composition. The term “added phosphates” is not meant to include phosphates present in minor amounts as natural constituents of other ingredients of the creamer composition.

In one embodiment, the creamer composition is substantially devoid of milk protein. By substantially devoid of milk protein is meant that no milk protein is added as such to the composition, and that any milk protein present originates from minor traces or impurities present in other ingredients, e.g. traces of milk protein present in lactose preparations or preparations of plant proteins. In one embodiment, the powdered creamer composition comprises less than 0.1% milk protein by weight, such as less than 0.01% milk protein.

In an embodiment, the creamer composition is a non-dairy creamer. Typical non-dairy creamers are components that give the visual and taste perception of milk in a beverage. Non-dairy creamers may comprise vegetable oils, carbohydrates, sodium caseinate or other proteins, and buffers. Non-dairy creamer may be preferred in some instances because it avoids some of the food sensitivity/allergen issues associated with milk proteins and carbohydrates (e.g., milk protein allergies and lactose intolerance). Sodium caseinate is not considered a dairy substance due to the extensive processing the ingredient has undergone. For example, in the USA, FDA regulation 21 CFR101.4 (d) allows caseinate in non-dairy products.

The creamer composition may further include one or more additional ingredients such as flavourings, carbohydrate, sweeteners, colorants, antioxidants, mouthfeel enhancers, texturisers (e.g. hydrocolloids) or a combination thereof.

Sweeteners can include, for example, sucrose, fructose, dextrose, maltose, dextrin, levulose, tagatose, galactose, corn syrup solids and other natural or artificial sweeteners. In an embodiment the creamer is lactose-free. Sugarless sweeteners can include, but are not limited to, sugar alcohols such as maltitol, xylitol, sorbitol, erythritol, mannitol, isomalt, lactitol, hydrogenated starch hydrolysates, and the like, alone or in combination. Usage level of the flavourings, sweeteners and colorants will vary greatly and will depend on such factors as potency of the sweetener, desired sweetness of the product, level and type of flavouring used and cost considerations. Combinations of sugar and/or sugarless sweeteners may be used. In one embodiment, a sweetener is present in the creamer composition of the invention at a concentration ranging from about 5-90% by weight of the total composition, such as in the range 5-80%, 20-90%, or 20-70%. In another embodiment, the sweetener concentration ranges from about 40% to about 60% by weight of the total composition.

In one embodiment, the creamer comprises a hydrocolloid. In another embodiment, the creamer does not comprise a hydrocolloid.

The term “hydrocolloids” relates to compounds that help to increase physical viscosity of the composition. Suitable hydrocolloids may be carrageenan, such as kappa-carragenan, iota-carragenan, and/or lambda-carragenan; starch, e.g. modified starch; cellulose, e.g. microcrystalline cellulose, methyl cellulose, or carboxy-methyl cellulose; agar-agar; gelatine; gellan (e.g., high acyl, low acyl); guar gum; gum Arabic; kojac; locust bean gum; pectin; sodium alginate; maltodextrin; tracaganth; xanthan; or a combination thereof.

In one embodiment, the creamer composition comprises sodium caseinate. The sodium caseinate may be present in amount of, for example 0.1 to 1.5 wt % or 0.2 to 1.2 wt %.

In another embodiment, the creamer composition does not comprise a caseinate, such as sodium caseinate.

In one embodiment, the only emulsifier present in the creamer composition is the polar lipid component referred to herein. In one embodiment, the only emulsifiers present in the creamer composition are the polar lipid component referred to herein, and sodium caseinate. For example, the only surface active emulsifier present in the creamer composition may be the polar lipid component referred to herein. For further example the only surface active emulsifiers present in the creamer composition are the polar lipid component referred to herein, and sodium caseinate.

Preferably, the creamer composition does not comprise any additional emulsifiers such as low molecular weight emulsifiers. By a low molecular weight emulsifier is meant an emulsifier with a molecular weight below 1500 g/mol. For example, the creamer composition may not comprise an emulsifier selected from the group consisting monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, diacetylated tartaric acid esters of monoglycerides, succinic acid esters of mono- and/or diglycerides, lactic acid esters of mono- and/or diglycerides, and sucrose esters of fatty acids, and combinations thereof.

In one embodiment the creamer composition comprises sodium caseinate and the additional emulsifiers refers to an emulsifier other than sodium caseinate.

Creamers and Capsules

The creamer composition of the invention may be a foaming creamer, i.e. a creamer that produces foam when dissolved in a liquid. Foaming creamers and methods for producing them are well known in the art. A foaming creamer may e.g. be a powdered creamer composition wherein the creamer powder particles are porous and gas is released from the pores upon dissolution to produce foam.

The invention further relates to a powdered coffee or tea beverage composition comprising soluble coffee or tea and, a powdered creamer composition according to the invention. By a powdered coffee or tea beverage composition is meant a powdered composition suitable for providing a coffee or tea beverage by dissolution in a liquid, preferably water, such as instant coffee or instant tea. Powdered coffee or tea beverage compositions comprising soluble coffee or tea in combination with powdered creamer are well known in the art. Powdered coffee or tea beverages may further comprise sweeteners, e.g. sugar, and flavours. In a preferred embodiment, the invention relates to a powdered coffee beverage comprising soluble coffee and a powdered creamer composition according to the invention. In another preferred embodiment, the invention relates to a powdered tea beverage comprising soluble tea and, a powdered creamer composition according to the invention.

In a further aspect the invention relates to a beverage capsule for a beverage preparation apparatus, the beverage capsule comprising the powdered creamer composition of the invention. Beverage capsules are well known in the art, and any suitable capsule construction may be used. In the scope of the present invention, the term capsule includes small flexible and/or rigid containers for example pouches. Suitable capsules are e.g. disclosed in WO03059778 and EP 0512468. The construction of the capsule will depend on the particular beverage machine(s) for which is intended to be used. Several such beverage machines adapted to the preparation of beverages from capsules exists and are well known in the art. The beverage capsule comprises a chamber wherein the powdered creamer composition of the invention is present. The chamber may be hermetically sealed or it may be partly open to the environment. Beverage capsules are constructed such that water, or another suitable liquid, can be injected into the chamber where the powdered creamer composition of the invention is present so that the powdered creamer composition is dissolved when a beverage is prepared from the capsule in a beverage preparation apparatus. The liquid with dissolved creamer is led from the capsule into a cup or other suitable container.

Method

The present invention provides a process for producing a creamer composition comprising the steps of:

(i) providing an aqueous phase;

(ii) providing an oil phase by mixing a polar oil component as defined herein with an oil such as an oil selected from the group consisting of palm oil, palm kernel oil or olein, hydrogenated palm kernel oil or olein, coconut oil, algal oil, canola oil, soy bean oil, sunflower oil, safflower oil, cotton seed oil, milk fat and corn oil;

(iii) combining the aqueous phase and the oil phase to form a pre-emulsion;

(iv) homogenising the pre-emulsion to form an emulsion concentrate;

(v) optionally drying the emulsion concentrate to form a dried creamer composition.

In step i) of the method an aqueous solution is prepared. Water soluble ingredients, e.g. carbohydrate, protein e.g., (caseinate), sodium bicarbonate, citric acid, and/or additional water soluble emulsifiers (if required), may be added to the aqueous solution at this stage.

In step (iii) the oil phase may be incorporated into the water mix under high agitation for e.g., 5 minutes. This mixture may then heated to e.g. 80° C. for 5 minutes.

In step (iv) the pre-emulsion is homogenised. The term “homogenizing” or “homogenized” or homogenization” is a unit operation using a class of processing equipment referred to as homogenizers that are geared towards reducing the size of droplets in liquid-liquid dispersions. Examples of homogenizers may include high speed blender, high pressure homogenizers, Colloid Mill, high shear dispersers, ultrasonic disruptor, membrane homogenizers.

Homogenised may take place at, for example, 250/50 bar.

In step v) of the method, the emulsion is dried to provide a powdered creamer composition. Drying may be performed by any suitable method, e.g. spray drying, roller drying, freeze drying, or the like.

In one embodiment of the invention, the method comprises mixing a gas into the liquid emulsion shortly before spray drying to produce a porous creamer powder. Any suitable gas may be used, such as e.g. nitrogen or carbon dioxide.

Pasteurizing, Sterilizing and Drying

The process of making the creamer composition of the present invention may comprise the step of pasteurizing or commercially sterilizing the oil-in-water emulsion.

The pasteurizing step may be performed at a minimum temperature of 81° C. for at least 5 seconds. The composition as obtained after the pasteurizing step can be used for making ready-to-drink beverages.

The process may comprises further steps of HTST (high temperature short time) or UHT (Ultra-high temperature processing) using either direct or indirect process; and Filled on a clean fill, ultra clean fill (ESL) or aseptic filler.

The process may also include a drying step. The drying step may be performed by spray drying, vacuum band drying, roller drying or freeze drying. The powdered creamer obtained after the drying step can be used for making powdered creamers for use in beverage industry for example as milk additive for coffee and tea beverage or for culinary applications such as creamy soups and sauces. Such a powdered creamer may also be used for preparation of capsules to be used in a beverage dispenser.

Those skilled in the art will understand that they can freely combine all features of the present invention described herein, without departing from the scope of the invention as disclosed.

Various preferred features and embodiments of the present invention will now be described by way of non-limiting examples.

### EXAMPLES

### Example 1—Powdered Creamer from Oat Oil

A powdered creamer was prepared by mixing two liquid concentrates (oil phase and water phase) to create a 135 kg concentrate.

The water phase was prepared by mixing 62.4 kg of glucose syrup (79% total solids) with 41.7 kg of water at 60° C.

The oil phase was prepared by mixing 3.4 kg of oat oil (SWEOAT OIL PL 40) with 27.6 kg of hydrogenated vegetable oil at 60° C.

The oil phase was then incorporated into the water mix under high agitation for 5 minutes. This mixture was then heated to 80° C. for 5 minutes, homogenised at 250/50 bar and spray dried to obtain a powder. The composition of the powder is in Table 1.1 below.

TABLE 1.1
Composition of Oat Oil Creamer Powder

| | % of powder |
|---|---|
| INGREDIENTS | by weight |
| Glucose Syrup solids | 66.9% |
| Hydrogenated vegetable oil | 29.5% |
| Oat oil PL40 | 3.6% |

### Example 2—Powdered Creamer from a Mixture of Oat Oil and Protein

A powdered creamer was prepared by mixing two liquid concentrates (oil phase and water phase) to create a 115 kg concentrate.

The water phase was prepared by mixing 53.1 kg of glucose syrup (79% total solids) with 35 kg of water with; 1.7 kg Na-Caseinate and 1.1 kg buffer salts already dissolved within it at 60° C.

The oil phase was prepared by mixing 0.6 kg of oat oil (SWEOAT OIL PL 40) with 23.5 kg of vegetable oil at 60° C.

The oil phase was then incorporated into the water mix under high agitation for 5 minutes. This mixture was then heated to 80° C. for 5 minutes, homogenised at 250/50 bar and spray dried to obtain a powder. The composition of the powder is in Table 1.2 below.

TABLE 1.2
Composition of a Powdered Creamer from
a mixture of Oat oil and protein.

| | % of powder |
|---|---|
| INGREDIENTS | by weight |
| Glucose Syrup solids | 66.8% |
| Vegetable oil | 29.3% |
| Na-Caseinate | 2.1% |
| Oat oil PL40 | 0.7% |
| Buffer salts | 1% |

### Example 3—Liquid Creamer from Oat Oil

A liquid creamer was prepared by mixing two liquid concentrates (oil phase and water phase) to create a 100 kg batch.

The water phase was prepared by mixing 61.8 kg of water, 29 kg of sucrose, 0.2 kg of hydrocolloid stabilizers and 0.4 kg of flavours at 60° C. The oil phase was prepared by mixing 8.2 kg of vegetable oil and 0.5 kg of oat oil at 60° C.

The oil phase was then incorporated into the water mix under high agitation for 5 minutes. This mixture was then heated to 80° C. for 5 minutes, homogenised at 250/50 bar and aseptically filled into bottles.

TABLE 1.3
Composition of a liquid Creamer from oat oil.

| | % formula |
|---|---|
| INGREDIENTS | by weight |
| Water | 61.8 |
| Sucrose granular | 29 |
| Vegetable oil | 8.2 |
| Oat Oil PL40 | 0.5 |
| Hydrocolloid stabilizers | 0.2 |
| Flavours | 0.4 |

### Example 4—Liquid Creamer from a Mixture of Oat Oil and Protein

A liquid creamer was prepared by mixing two liquid concentrates (oil phase and water phase) to create a 100 kg batch.

The water phase was prepared by mixing 60.5 kg of water, 29 kg of sucrose, 8.2 kg vegetable oil, 0.9 kg of sodium caseinate, 0.4 kg of buffer salts, 0.2 kg of hydrocolloid stabilizers and 0.4 kg of flavours at 60° C. The oil phase was prepared by mixing 8.2 kg of vegetable oil and 0.5 kg of oat oil at 60° C.

The oil phase was then incorporated into the water mix under high agitation for 5 minutes. This mixture was then heated to 80° C. for 5 minutes, homogenised at 250/50 bar and aseptically filled into bottles. The composition of the powder is in Table 1.4 below.

TABLE 1.4
Composition of a liquid Creamer from
a mixture of Oat oil and protein.

| | % formula |
|---|---|
| INGREDIENT | by weight |
| Water | 60.5 |
| Sucrose granular | 29.0 |
| Vegetable oil | 8.2 |
| Na-CASEINATE | 0.9 |
| Oat Oil PL40 | 0.5 |
| Buffer salts | 0.4 |
| Hydrocolloid stabilizers | 0.2 |
| Flavours | 0.4 |

### Example 5—Particle Size Distribution of Creamers

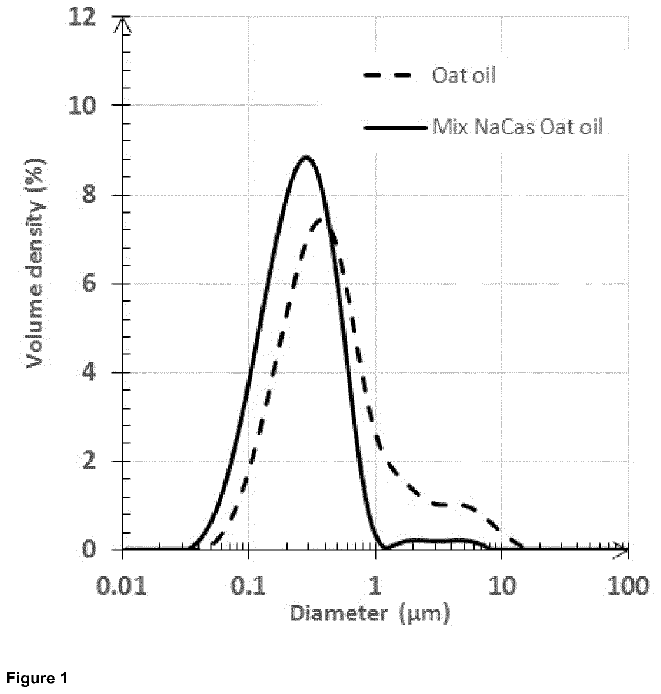

The Particle size distribution of rehydrated powdered creamers from examples 1 and 2 is shown in FIG. 1.

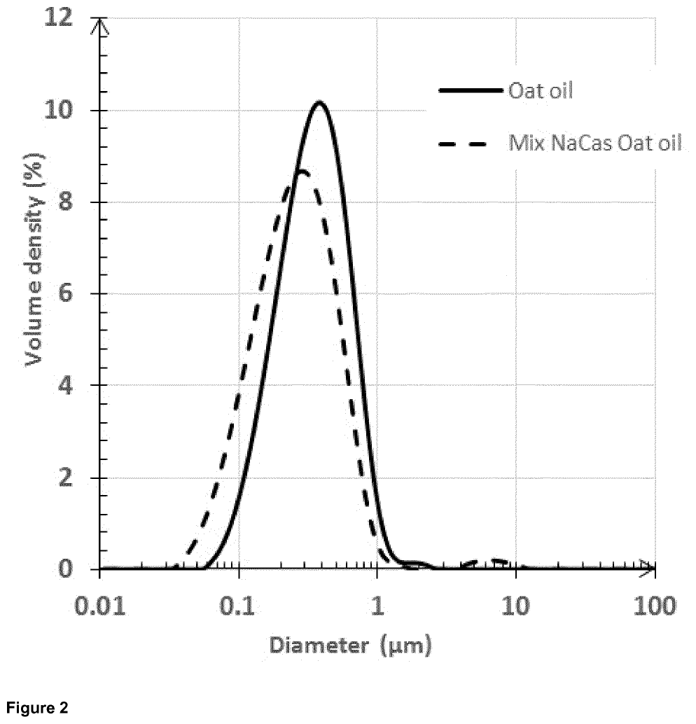

The Particle size distribution of rehydrated powdered creamers from examples 3 and 4 is shown in FIG. 2

The particle size distribution shows that the polar lipids derived from oat oil can successfully be used as an effective emulsifier in creamer compositions.

### Example 6—Stability of Creamers

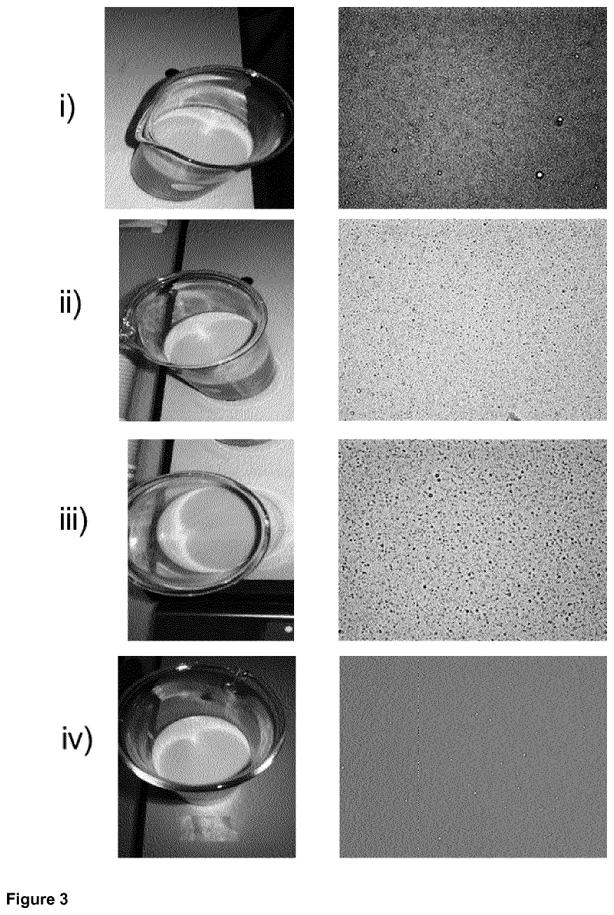

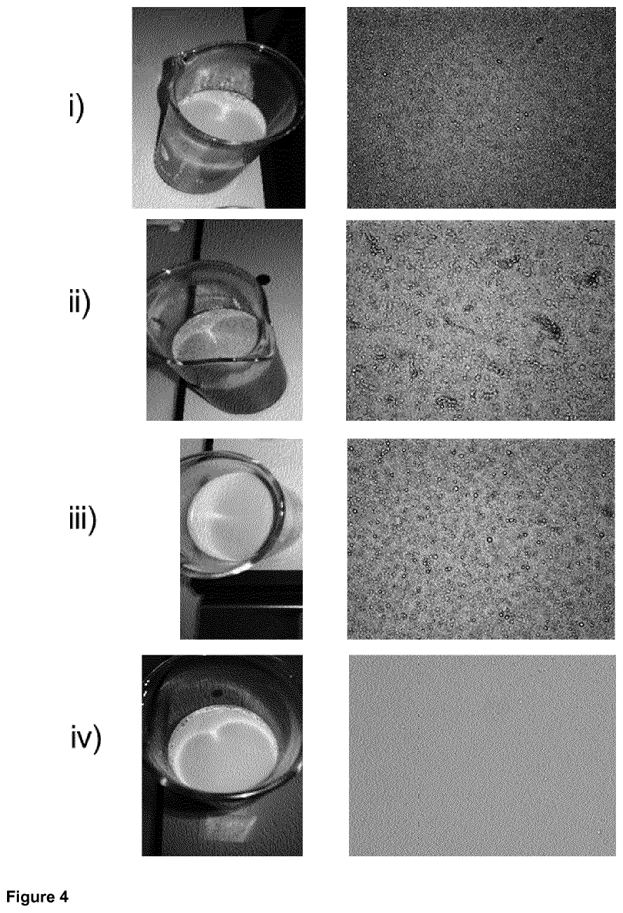

FIGS. 3 to 5 compare the stability of: i) a reference coffee creamer made with synthetic emulsifiers and buffering agents, ii) a coffee creamer made with Na-caseinate only, iii) a coffee creamer with only oat oil and iv) a coffee creamer made with Na-caseinate and oat oil. Compositions of these creamers are provided in Table 2 below.

TABLE 2
Composition of Creamer

| | | ii) | iii) | iv) |
|---|---|---|---|---|
| | i) | Casein | Oat | Casein/ |
| Creamer | Reference | Only | Only | Oat Mix |
| Ingredients | % | % | % | % |
| Hydrogenated | 8.2 | 8.2 | 8.2 | 8.2 |
| vegetable oil | | | | |
| Na-Caseinate | 0.9 | 0.9 | 0 | 0.45 |
| Emulsifiers (mono and | 0.4 | | | |
| diglycerides and their | | | | |
| esters) | | | | |
| Oat Oil - PL40 | — | — | 0.5 | 0.2 |
| Buffer salts | 0.4 | 0.4 | — | 0.4 |
| Hydrocolloid stabilizers | 0.3 | — | — | — |
| Glucose Syrup liquid | 20 | 20 | 20 | 20 |

Water for completion

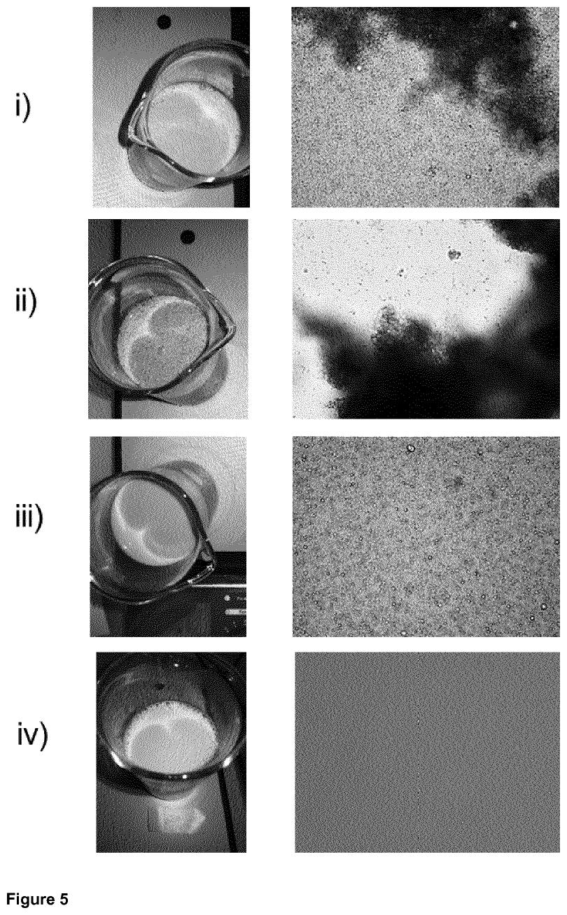

Surprisingly, the coffee creamer based on oat oil has superior stability to coffee creamer containing Na-caseinate only. Even more surprisingly, the coffee creamer based on oat oil, has superior stability at high calcium levels even when compared to the reference coffee creamer (650 ppm calcium, FIG. 5). The coffee creamer based on oat oil has 5 fewer ingredients than the reference coffee creamer and no synthetic emulsifiers or buffering agents.

Thus, the inventors were able to make a emulsion based coffee creamer that was stable to high acid and high calcium contents without the need for multiple emulsifiers, without the need for synthetic emulsifiers and without the need for buffer agents.

### Example 7—Digestibility of Oat Oils

Chu et al (Langmuir (2009), 25(16), 9352-9360) discloses that the lipids in oat oil based emulsions act to inhibit or slow fat digestion. The inhibition/slowing of fat digestion has been shown to have adverse nutritional effects, such as inhibiting vitamin uptake and causing malabsorption of fats.

The inventors surprisingly found that emulsions made using a combination of glycolipids and phospholipids did not inhibit nor slow fat digestion thereby allowing the creation of natural emulsion based creamers that do not have negative nutritional consequences.

### Example 8—Deodorised Oat Oil

Oat oil with 40% polar lipids was deodorised by low temperature high vacuum thin film distillation to remove volatile off-flavours.

For proper deodorization of vegetable oils in standard chemical or physical refining processes, low amount of phosphorus (5-10 ppm)—e.g. due to phospholipids—is a requirement as it would otherwise induce colour and taste degradation of the oil. Oat oil with 40% polar lipids contains slightly less than 20% of phospholipids. Standard deodorization can therefore not be used.

In order to achieve proper deodorization and remove volatile off-flavours, a short-path distillation device (UIC KDL-5-UIC GmbH, Alzenau-Horstein, Germany) was used with the following conditions: pressure=0.001 to 0.03 mbar and temperature 60° to 70° C. Conditions were chosen to achieve required viscosity and avoid chemical damage to oat oil.

In an alternate process, oat oil with 40% polar lipids was first diluted with refined vegetable oil in ratio 1:1. The vegetable oil used was either high oleic sunflower or palm kernel oil. One to three sequential passes of short-path distillation were applied to achieve required quality.

The effect of such distillation on the sensory properties of coffee creamers was assessed using sensory discriminatory testing (3 AFC—alternative forced choice) methodology. Coffee creamers prepared with a mixture of oat oil (deodorised and non-deodorised) and Na-Caseinate (as per Casein/Oat Mix example in Table 2) were added to coffee and compared to coffee's containing the reference creamer of Table 2.

This sensory discriminatory testing shows that deodorised oat oil does not have the strong negative odour associated with un-processed oat oil.

Various preferred features and embodiments of the present invention will now be described with reference to the following numbered paragraphs (paras).
1. A creamer composition wherein 0.1 to 15 wt % of the lipids in said composition are polar lipids, wherein the polar lipids comprise a glycolipid, for example wherein the total lipid content of the creamer composition is in the range 1% to 60% (weight/weight), for further example 1% to 50% (weight/weight).
2. A creamer composition according to para 1 wherein 0.4 to 14 wt %, 0.6 to 12 wt % or 0.7 to 10 wt % of the lipids in said composition are polar lipids.
3. A creamer composition according to para 1 or 2 wherein at least 20 wt % of the polar lipids are galactolipids, preferably wherein at least 20 wt % of the polar lipid are digalactosyldiacylglycerides.
4. A creamer composition according to any preceding para wherein the polar lipids also comprise phospholipids.
5. A creamer composition according to any preceding para wherein the polar lipids are derived from oat, spinach or sweet potatoes.
6. A creamer composition according to any preceding para wherein 0.5 to 35 wt % of the lipids in said composition are derived from oat, and wherein at least 4%, at least 15%, at least 35% or at least 40% by weight of the lipid derived from oat are polar lipids.
7. A creamer composition according to para 6 wherein 0.5 to 35 wt % of the lipids in said composition are derived from oat and 65 to 99.5 wt % of the lipids in said composition are palm oil, palm kernel oil or olein, hydrogenated palm kernel oil or olein, coconut oil, algal oil, canola oil, soy bean oil, sunflower oil, safflower oil, cotton seed oil, milk fat, or corn oil.
8. A creamer composition according to para 6 or 7 wherein 5 to 25 wt % of the lipids in said composition are derived from oat and 75 to 95 wt % of the lipids in said composition are palm oil, palm kernel oil or olein, hydrogenated palm kernel oil or olein, coconut oil, algal oil, canola oil, soy bean oil, sunflower oil, safflower oil, cotton seed oil, milk fat, or corn oil.
9. A creamer composition according to any one of paras 5 to 8 wherein the oils derived from oat are prepared by low temperature high vacuum distillation, for example a distillation wherein the pressure is 0.001 to 0.03 mbar and temperature is 30° to 75° C., for example 60° to 70° C.
10. A creamer composition according to any preceding para wherein the creamer composition comprises sodium caseinate.
11. A creamer composition according to any preceding para wherein the creamer composition comprises no additional emulsifiers.
12. A creamer composition according to any one of paras 1 to 9 or 11 wherein the creamer composition is substantially devoid of milk protein.
13. A creamer composition according to any preceding para wherein the creamer composition is substantially devoid of added phosphates.
14. A creamer composition according to any preceding para, wherein the composition is a beverage creamer, preferably a coffee creamer.
15. A creamer composition according to any preceding para comprising 10-60 wt % oil (for example 10-50 wt % oil) and 5-80 wt % carbohydrate on a dry weight basis.
16. A creamer composition according to any preceding para wherein the composition is in the form of a powdered creamer.
17. A creamer composition according to any preceding para wherein the composition is in the form of a liquid creamer.
18. A coffee beverage composition comprising the creamer composition of any one of the preceding paras and a coffee component, preferably a dried coffee component.
19. A ready-to-drink or ready to use beverage comprising a creamer according to any one of paras 1 to 15.
20. Use of a polar lipid comprising a glycolipid as an emulsifier in a creamer composition, preferably wherein polar lipid comprises a digalactosyldiacylglyceride.
21. Use of oat oil, spinach oil or sweet potato oil as an emulsifier in a creamer composition, preferably wherein the oil is prepared using low temperature high vacuum distillation, for example a distillation wherein the pressure is 0.001 to 0.03 mbar and temperature is 30° to 75° C., for example 60° to 70° C.
22. Use according to para 20 or 21 wherein the polar lipid, or oat oil, spinach oil or sweet potato oil, is used to reduce acid instability of a creamer composition.

23. A process for producing a creamer composition according to any one of paras 1 to 17 comprising the steps of:

(i) providing an aqueous phase;

(ii) providing an oil phase by mixing oat oil with an oil selected from the group consisting of palm oil, palm kernel oil or olein, hydrogenated palm kernel oil or olein, coconut oil, algal oil, canola oil, soy bean oil, sunflower oil, safflower oil, cotton seed oil, milk fat and corn oil;

(iii) combining the aqueous phase and the oil phase to form a pre-emulsion;

(iv) homogenising the pre-emulsion to form an emulsion concentrate;

(v) optionally drying the emulsion concentrate to form a dried creamer composition.
24. A process according to para 23 wherein the oat oil has been subjected to a low temperature high vacuum distillation, for example a distillation wherein the pressure is 0.001 to 0.03 mbar and temperature is 30° to 75° C., for example 60° to 70° C.

1. A creamer composition wherein 0.1 to 15 wt % of the lipids in the composition are polar lipids, wherein the polar lipids comprise a glycolipid.

2. A creamer composition according to claim 1 wherein 0.4 to 14 wt % of the lipids in the composition are polar lipids.

3. A creamer composition according to claim 1 wherein at least 20 wt % of the polar lipids are galactolipids.

4. A creamer composition according to claim 1 wherein the polar lipids also comprise phospholipids.

5. A creamer composition according to claim 1 wherein the polar lipids are derived from oat, spinach or sweet potatoes.

6. A creamer composition according to claim 1 wherein 0.5 to 35 wt % of the lipids in the composition are derived from oat, and wherein at least 4%, at least 15%, at least 35% or at least 40% by weight of the lipid derived from oat are polar lipids.

7. A creamer composition according to claim 6 wherein 0.5 to 35 wt % of the lipids in the composition are derived from oat and 65 to 99.5 wt % of the lipids in the composition are selected from the group consisting of palm oil, palm kernel oil or olein, hydrogenated palm kernel oil or olein, coconut oil, algal oil, canola oil, soy bean oil, sunflower oil, safflower oil, cotton seed oil, milk fat, and corn oil.

8. A creamer composition according to claim 5 wherein the oils derived from oat are prepared by low temperature high vacuum distillation.

9. A creamer composition according to claim 1 wherein the creamer composition comprises no additional emulsifiers and/or is substantially devoid of added phosphates.

10. A creamer composition according to claim 1, wherein the composition is a beverage creamer.

11. A creamer composition according to claim 1 comprising 10-60 wt % oil and 5-80 wt % carbohydrate on a dry weight basis.

12. A creamer composition according to claim 1 wherein the composition is in the form of a powdered creamer or a liquid creamer.

13. A ready-to-drink or ready to use beverage comprising a creamer composition wherein 0.1 to 15 wt % of the lipids in the composition are polar lipids, wherein the polar lipids comprise a glycolipid.

14. (canceled)

15. A process for producing a creamer composition comprising the steps of:
(i) providing an aqueous phase;
(ii) providing an oil phase by mixing oat oil with an oil selected from the group consisting of palm oil, palm kernel oil or olein, hydrogenated palm kernel oil or olein, coconut oil, algal oil, canola oil, soy bean oil, sunflower oil, safflower oil, cotton seed oil, milk fat and corn oil;
(iii) combining the aqueous phase and the oil phase to form a pre-emulsion;
(iv) homogenising the pre-emulsion to form an emulsion concentrate; and
(v) drying the emulsion concentrate to form a dried creamer composition.
